(19) United States
(12) Patent Application Publication
(10) Pub. No.: US 2009/0162591 A1
(43) Pub. Date: Jun. 25, 2009

(54) Multilayer coolant pipes

(76) Inventors: Shailesh Ratilal Doshi, Kingston (CA); Jean-Michel Philippoz, Prangins (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/157,896

(22) Filed: Jun. 13, 2008

Related U.S. Application Data
(60) Provisional application No. 60/936,722, filed on Jun. 22, 2007.

(51) Int. Cl. B32B 1/08; B29C 65/02

(52) U.S. Cl. 428/36.91; 156/296

(57) ABSTRACT

The present invention relates to the field of multilayer pipes used to convey liquid media for automotive applications. Disclosed pipes show a balance of properties, in terms of ageing in presence of coolant liquid, burst pressure resistance, permeation rate and coolant liquid absorption compared to conventional pipes.

### CROSS REFERENCE TO RELATED APPLICATIONS

This application claims the benefit of U.S. Provisional Application No. 60/936,722, filed Jun. 22, 2007.

### FIELD OF INVENTION

The present invention relates to the field of multilayer pipes used to convey liquid media for automotive applications.

### DESCRIPTION OF THE RELATED ART

Hollow structures made of thermoplastic are well known for a variety of applications, like for example in the building industry for water pipes, radiator pipes or floor-heating pipes or in automotive conduits to carry many different fluids or liquid media and are desired to display an outstanding balance of properties including thermal, mechanical and chemical resistances. In the automotive industry for example, and especially for structures made of thermoplastic materials and used to convey liquid media, such structures (pipes, ducts, conduits, tubes, tubings, etc.) are desired to retain their structural integrity in the face of both internal exposure to the liquid being conveyed and external exposure to the surrounding environment.

Coolant conduits composed of a single polyolefin layer do not withstand high bursting pressure and especially fail at high temperature, i.e. at temperatures higher than 100° C., which are often reached in underhood areas of automobiles. Coolant conduits composed of a single polymer layer made of polyamide and glass fibers have been developed to partially compensate for the loss of mechanical properties due to the swelling of polyamide on contact with coolant liquid. Such reinforced polyamide conduits are often not flexible enough for the application, and also not resistant enough to the conveyed liquid. Such monolayer structures have been used to a limited extent in automotive applications.

Multilayer structures have been developed to overcome such problems. The layers of such structures often comprise dissimilar materials to satisfy specified performance criteria by placing different materials at the most appropriate position in the structure.

The outside layers of such pipes, which are in contact with the surrounding environment, are often desired to have a high resistance to bursting pressures. The inner layers are often desired to be inert to conveyed fluids, and to have good barrier properties. By inert, it is not only meant that absorption of the fluid is low so that no swelling or undesirable dimensional changes occur in the pipes, but it also meant that the permeation of fluids through the walls of the pipe is avoided in order to avoid loss of contained fluid, to meet the requirements of environmental protection and safety and to avoid any damage to the outer layer.

U.S. Pat. No. 6,592,957 discloses multilayer hoses for automobile cooling systems comprising at least two layers, wherein the hose is used for conveying an aqueous anti-freeze solution. The outer layer is made of a polyamide thermoplastic resin; the inner layer is made of a composition comprising a polymer containing dynamically cross-linked olefin thermoplastic elastomer in combination with a polymer having a carboxyl group and/or its derivative group in the molecule.

U.S. Pat. No. 5,706,864 discloses partially corrugated multilayer conduits for coolant. The external layer is made of a member of the group consisting of homopolyamides or copolyamides which may further comprise additives; the inner layer is made of a polymer selected from the group consisting of halogenated and non-halogenated homopolyolefins and copolyolefins and mixtures and blends thereof.

U.S. Pat. No. 5,560,398 discloses multilayer coolant conduits made by a sequential co-extrusion process for an apparatus requiring cooling by a cooling agent. The plurality of layers in adjoining sections comprise of different materials. The outer layer is made of a material comprising at least one polyamide which is selected from the group consisting of homopolyamides and copolyamides; the inner layer is either made of a) a polymeric material which is at least one polymer selected from the group consisting of halogenated or non-halogenated polyolefins and copolyolefins and includes at least one functional group which causes the inner layer to be compatible with the outer layer or b) a polymeric material, which is at least one polymer selected from the group consisting of polyolefins having one of grafted alpha-unsaturated dicarboxylic acids or their derivatives, and copolyolefins having one of grafted alpha-unsaturated dicarboxylic acids or their derivatives.

EP 0436923 discloses flexible multilayer coolant conduits for engines which have annularly or spirally-corrugated walls. The outer layer consists of a homopolyamide or copolyamide or mixtures or blends thereof and the inner layer consists of halogenated or non-halogenated homopolyolefins or copolyolefins, or mixtures or blends thereof. When the outer layer is not compatible with the inner layer, a third and intermediate layer made of polyolefin or copolyolefin containing functional groups by grafting or copolymerization is used.

DE 4428236 discloses multilayer conduits for carrying fluids, like for example aqueous glycol solutions. The inner layer is made of a composition comprising an elastomer, a functionalized copolyolefin and a polyamide and the outer layer is made of a polyamide.

A need remains for flexible multilayer pipes for conveying liquid media such as for example, coolant liquids in vehicles, and especially in automobile cooling systems, that have a good balance of properties in terms of ageing, burst pressure resistance, permeation resistance and coolant absorption reduction.

### SUMMARY OF THE INVENTION

The inventors have found that the use of pipes having a combination of layers of suitable polymer compositions are particularly appropriate as coolant pipes since these pipes show a balance of properties, in terms of ageing in presence of coolant liquid, burst pressure resistance, permeation rate and coolant liquid absorption compared to conventional pipes.

In a first aspect, the invention provides a multilayer pipe comprising at least two layers,

i) an inside layer comprises or consists essentially of:
a) from at or about 65 to at or about 90 wt-% of at least two polymers one of which is a polyethylene, polypropylene, or a combination thereof, and the other is an ethylene alpha-olefin copolymer, an ethylene propylene diene rubber (EPDM), or a combination thereof; and
b) from at or about 10 to at or about 35 wt-% of at least one functionalized polyolefin,
the weight percentage being based of the total weight of the inside layer, and

ii) an outside layer comprises or consists essentially of:
a) from at or about 50 to at or about 80 wt-% of at least one aliphatic polyamide derived from monomers comprising at least one diamine having 6 to 14 carbon atoms and at least one aliphatic dicarboxylic acid having 9 to 18 carbon atoms;
b) from at or about 10 to at or about 30 wt-% of one or more functionalized polyolefins or maleic anhydride grafted ethylene/alpha-olefin copolymer or maleic anhydride grafted ethylene-propylene diene rubber or a combination thereof;
c) from at or about 0 to at or about 30 wt-% of linear low density polyethylene (LLDPE),
the weight percentage being based on the total weight of the outside layer; and
wherein the inside layer contacts the outside layer.

In a second aspect, the invention provides a method for bonding one or more multilayer pipes to one or more pipe fittings.

### DETAILED DESCRIPTION OF THE INVENTION

The terms “pipe”, “duct”, “conduit”, “tube” and “tubings” are used interchangeably herein to denote an elongated hollow body used to convey liquid media.

The multilayer pipe according to the present invention comprises an outside layer made of a polyamide composition to confer rigidity and strength to the overall structure and to contain internal pressure. Since the pipe is in contact with the environment of the vehicle hood, it is desirable that the material have high resistance to a variety of media (e.g. gasoline, oil, transmission fluid, power steering fluid, radiator fluid, lubricating greases and the like) and to environmental conditions like high temperatures. Thermoplastic resins based on polyamide combine excellent structural strength, toughness and dimensional stability at typical ambient conditions and in harsh environments. Such harsh environments can involve long or short term exposure to elevated temperature, high humidity and chemicals like automotive fluids.

The outside layer of the multilayer pipe of the present invention comprises from at or about 50 to at or about 80 wt-% of at least one aliphatic polyamide derived from at least one aliphatic diamine having 6 to 14 carbon atoms and at least one aliphatic dicarboxylic acid having 9 to 18 carbon atoms, the weight percentage being based on the total weight of the outside layer. The aliphatic diamine is preferably a fully aliphatic diamine.

By the term “derived from” is meant that the polyamide is made by polymerizing monomers comprising the at least one aliphatic diamine and the at least one aliphatic dicarboxylic acid. By the term “dicarboxylic acid” is meant dicarboxylic acids and their derivative, including diesters, monoesters, anhydrides, amides, nitriles, and the like.

Preferred aliphatic diamines include 1,6-diaminohexane (hexamethylenediamine); 1,10-diaminodecane; and 1,12-diaminododecane. Preferred aliphatic dicarboxylic acids include sebacic acid; dodecanedioic acid; and azelaic acid.

Preferred aliphatic polyamides include polyamide 610 (PA 610); polyamide 612 (PA 612); polyamide 1010 (PA 1010); polyamide 1012 (PA 1012); and polyamide 1212 (PA 1212). Polyamide 610 (PA 610, also called poly(hexamethylene sebacamide) or nylon 610) is a fully aliphatic polyamide which consists of a copolymer having repeating units derived from a dicarboxylic acid component and a diamine component, wherein the diamine component is hexamethylene diamine and the dicarboxylic acid component is sebacic acid. Polyamide 612 (PA 612, also called poly(hexamethylene dodecanoamide) or nylon 612) is a fully aliphatic polyamide which consists of a copolymer having repeating units derived from a dicarboxylic acid component and a diamine component, wherein the diamine component is hexamethylene diamine and the dicarboxylic acid component is dodecanedioic acid. Polyamide 1010 (PA 1010, also called poly(decamethylene sebacamide) or nylon 1010) is a fully aliphatic polyamide which consists of a copolymer having repeating units derived from a dicarboxylic acid component and a diamine component, wherein the diamine component is decamethylene diamine and the dicarboxylic acid component is sebacic acid. Preferably, PA 612 is used in the outside layer of the multilayer pipe of the present invention. Suitable examples of polyamide 612 useful in the polyamide composition of the outside layer of the present invention are commercially available under the trademark Zytel® from E. I. du Pont de Nemours and Company, Wilmington, Del.

The outside layer of the multilayer pipe of the present invention further comprises from at or about 10 to at or about 30 wt-% of one or more functionalized polyolefins or maleic anhydride grafted ethylene alpha-olefin copolymer or maleic anhydride grafted ethylene-propylene diene rubber or a combination thereof, the weight percentage being based on the total weight of the outside layer.

The term “functionalized polyolefin” refers to an alkylcarboxyl-substituted polyolefin, which is a polyolefin that has carboxylic moieties attached thereto, either on the polyolefin backbone itself or on side chains. By “carboxylic moiety” is meant one or more carboxylic groups, such as carboxylic acids, carboxylic acid ester, carboxylic acid anhydrides, and carboxylic acid salts.

Functionalized polyolefins may be prepared by direct synthesis or by grafting. An example of direct synthesis is the polymerization of ethylene and/or at least one α-olefin with at least one ethylenically unsaturated monomer having a carboxylic moiety. An example of grafting is the addition of at least one ethylenically unsaturated monomer having at least one carboxylic moiety to a polyolefin backbone. The ethylenically unsaturated monomers having at least one carboxylic moiety may be, for example, mono-, di-, or polycarboxylic acids and/or their derivatives, including esters, anhydrides, salts, amides, imides, and the like.

Suitable ethylenically unsaturated monomers include methacrylic acid; acrylic acid; ethacrylic acid; glycidyl methacrylate; 2-hydroxy ethylacrylate; 2-hydroxy ethyl methacrylate; diethyl maleate; monoethyl maleate; di-n-butyl maleate; maleic anhydride; maleic acid; fumaric acid; mono- and disodium maleate; acrylamide; glycidyl methacrylate; dimethyl fumarate; crotonic acid, itaconic acid, itaconic anhydride; tetrahydrophthalic anhydride; monoesters of these dicarboxylic acids; dodecenyl succinic anhydride; 5-norbornene-2,3-anhydride; nadic anhydride (3,6-endomethylene-1,2,3,6-tetrahydrophthalic anhydride); nadic methyl anhydride; and the like. Maleic anhydride is preferred.

Grafted functionalized polyolefins are preferably derived by grafting at least one monomer having at least one carboxylic moiety to polyethylene; polypropylene; a copolymer of ethylene and at least one α-olefin having 3-8 carbon atoms such as propylene, and the like; or a copolymer derived from at least one α-olefin having 3-8 carbon atoms and a diene, such as butadiene, 1,4-hexadiene, norbornadiene, and the like. About 0.05 to about 6 wt-% of the grafted functionalized polyolefins comprises the grafted ethylenically unsaturated monomer. Grafted polymers and their preparation are described in greater detail in U.S. Pat. Nos. 4,026,967; 4,612,155 and 3,953,655.

Functionalized polyolefins prepared by the direct synthesis can be made by copolymerizing one or more of ethylene, propylene, another α-olefin, and the like with at least one monomer having at least one carboxylic moiety.

The functionalized polyolefin comprising about 10 to about 30 wt-% of the composition of the outside layer of the multilayer pipe of the present invention is maleic anhydride grafted polyethylene (MAH-g-PE) or maleic anhydride grafted polypropylene (MAH-g-PP).

Polyethylenes used for preparing maleic anhydride grafted polyethylene (MAH-g-PE) are commonly available polyethylene resins selected from HDPE (density higher than 0.94 g/cm³), LLDPE (density of 0.915-0.925 g/cm³) or LDPE (density of 0.91-0.94 g/cm³). LLDPE and LDPE are preferred as they provide better impact toughening properties of PA 612 formulation. Polypropylenes used for preparing maleic anhydride grafted polypropylene (MAH-g-PP) are commonly available copolymer or homopolymer polypropylene resins. Ethylene alpha-olefins copolymers comprise ethylene and one or more alpha-olefins. Examples of alpha-olefins include but are not limited to propylene, 1-butene, 1-pentene, 1-hexene-1,4-methyl 1-pentene, 1-heptene, 1-octene, 1-nonene, 1-decene, 1-undecene and 1-dodecene. The term “ethylene propylene diene elastomers (EPDM)” is used herein to mean any elastomer that is a terpolymer of ethylene, at least one alpha-olefin, and a copolymerizable non-conjugated diene such as norbornadiene, 5-ethylidene-2-norbornene, dicyclopentadiene, 1,4-hexadiene and the like. Preferably, the EPDM used for the present invention is a terpolymer of ethylene propylene and at least one diene selected from 4-hexadiene, norbornadiene, ethylidene norbornene and mixtures thereof. Preferably the ethylene propylene diene polymers used in the outside layer of the multilayer pipe of the present invention comprise from at or about 50 to at or about 80 wt-% of ethylene, from at or about 10 to at or about 50 wt-% of propylene and from at or about 0.5 to at or about 10 wt-% of at least one diene. Since polyolefins and olefinic rubbers are incompatible with polyamides, it is necessary to modify them with functional groups that are capable of reacting with the acid or amine ends of the polyamide polymer. Due to the fact that the reaction of an anhydride with an amine is very fast, anhydrides are preferred grafting agents and more preferably maleic anhydride is chosen. The grafting monomers can be present in the grafted polymer in an amount from at or about 0.05 to at or about 6 wt-%, preferably from at or about 0.1 to at or about 2.0 wt-%, the weight percentage being based of the total weight of the functionalized polymer.

The outside layer of the multilayer pipe of the present invention may further comprise from at or about 0 to at or about 30 wt-% of linear low density polyethylene (LLDPE), the wt-% being based on the total weight of the outside layer. By linear low density polyethylene, it is meant a polymer produced by polymerizing ethylene and having a density from about 0.91 g/cm³ to about 0.935 g/cm³. When used, the LLDPE is preferably present in about 2 to about 30 wt-%, or more preferably in about 5 to about 25 wt-%. In one embodiment of the present invention, when the LLDPE is used, it is preferred that it be used in amounts that are about equal to those of the functionalized polyolefin used in the outside layer.

Since the inside layer is in direct contact with the liquid media to be conveyed and especially with coolant liquids, the material is required to have high barrier properties to permeation of liquid and vapor and have a minimum absorption of the liquid to avoid any swelling and dimensional changes of the pipe structure. Furthermore, it is important that the material does not suffer from any deterioration leading to the loss of properties upon long term contact with the coolant medium. By coolant media, it is meant organic fluids and solutions of organic molecules that contain anti-freeze agents comprising alcohols and glycols such as methanol, ethanol, ethylene glycol, diethylene glycol, propylene glycol, propane diol and their mixtures with water.

The inside layer of the multilayer pipe of the present invention comprises as a major polymeric fraction, i.e. from at or about 65 to at or about 90 wt-%, a polyolefin based polymer, the weight percentage being based on the total weight of the inside layer. The major polymeric fraction of the inside layer of the multilayer pipe according to the present invention comprises at least two polymers chosen among homopolymers or copolymers mainly composed of an olefin having C₂-C₁₂ carbon atoms as follows. At least one polymer comprised in the major fraction of the inside layer of the multilayer pipe according to the invention is preferably chosen among polyethylene, polypropylene or a combination thereof; and the other is chosen from at least one ethylene alpha-olefin copolymer; ethylene propylene diene rubber (EPDM) or a combination thereof. As described above for the outside layer, polyethylenes for use in the inside layer may be chosen among HDPE, LLDPE or LDPE.

The inside layer of the multilayer pipe of the present invention comprises as a minor polymeric fraction, i.e. from at or about 10 to at or about 35 wt-%, of a functionalized polyolefin, the weight percentage being based on the total weight of the inside layer. As described above, the term “functionalized polyolefin” refers to a polyolefin that has carboxylic moieties attached thereto, either on the polyolefin backbone itself or on side chains. Preferably, the functionalized polyolefin used in the inside layer of the multilayer pipe of the present invention is maleic anhydride grafted polyethylene (MAH-g-PE) or maleic anhydride grafted polypropylene (MAH-g-PP). When the major polymeric fraction of the inside layer is comprised of polyethylene, it is preferable to use MAH-g-PE, while when it is comprised of polypropylene, it is preferable to use MAH-g-PP in order to ensure better compatibility.

As described before, the terms “maleic anhydride grafted polyethylene” and “maleic anhydride grafted polypropylene” refer to a homopolymer of ethylene, respectively propylene, onto which is grafted ethylenically unsaturated carboxylic acid anhydrides, i.e. maleic anhydrides. The grafting monomers, i.e. maleic anhydrides, can be present in the grafted polyethylene or polypropylene in an amount from at or about 0.05 to at or about 6 wt-%, the weight percentage being based on the total weight of the functionalized polyethylene or polypropylene. Functionalized polyolefins are well known in the art and can be produced by a variety of processes such as those described in U.S. Pat. No. 4,612,155.

The inside layer and the outside layer of the multilayer pipe of the present invention may further include modifiers and other ingredients, including, without limitation, reinforcing agents (e.g. glass fibers, glass flakes, carbon fibers, aramid fibers, mica, wollastonite, clay, kaolin, metal sulfate, titanium dioxide, sodium aluminum carbonate, barium ferrite, potassium titanate and the like), antioxidants, ultraviolet light stabilizers, heat stabilizers, flame retardant agents (e.g. metal oxides, metal powders, metal salts, halogenated organic compounds, melamine pyrophosphate, melamine cyanurate, melamine polyphosphate, red phosphorus, and the like), plasticizers (such as alkyl benzene sulfonamides), lubricants and mold release agents (e.g. stearic acid, stearyl alcohol and stearamides, and the like), conductive or antistatic agents, coloring agents (e.g. dyes, pigments, carbon black, and the like), nucleating agents (talc, calcium fluoride, salts of phosphoric acid, and the like), crystallization promoting agents and other processing aids known in the polymer compounding art. These additives may be present in the composition in amounts and in forms well known in the art, including in the form of so-called nano-materials where at least one of the dimensions of the particles is in the range of 1 to 1000 nm.

The inside layer contacts the outside layer. By “contacts” is meant that the inside layer substantially directly contacts the outside layer over the length and circumference of the pipe.

According to another embodiment, the multilayer pipe according to the present invention may further comprise one or more additional layers, which layers are situated over the outside layer or inside the inside layer of the pipe of the invention. The one or more additional layers include but are not limited to braidings, reinforcement layers, thermal shields and softer cover layers. Examples of braidings may be filament braidings with polyamide, aramid, polyethylene terephthalate (PET) or metallic filaments and woven fabrics of these materials. Examples of thermal shields may be metallic foils such as aluminum foils. Examples of softer cover layers may be layers made of rubber or of a thermoplastic elastomer.

The compositions used for the inside layer and for the outside layer of the multilayer pipe of the present invention are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the layers of the multilayer pipe of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

The multilayer pipe according to the present invention can be manufactured by conventional processes like for example co-extrusion, blow molding, injection molding, and corrugated extrusion, with co-extrusion being preferred. In a multilayer co-extrusion process, separate extruders are used to extrude each type of polymeric compositions. The temperature settings and other processing conditions for the extruders are arranged such that they are appropriate to the polymeric composition being extruded. This avoids having to expose lower melting polymeric compositions to higher than normal processing temperatures during the extrusion step while allowing the extrusion of higher melting polymeric compositions at a suitable temperature. The individual melts from the extrusion streams are combined together in a suitably designed die and arranged in the desired multilayer arrangement.

The dimensions (i.e. the internal diameter and external diameter of the multilayer pipe as well as the thickness of each layer) of the multilayer pipe according to the present invention are not limited, but may be governed by the end-use application. The total thickness of the multilayer pipe is adapted so as to contain the imposed internal and/or external pressure. The ratio of the thickness of the inside layer and the outside layer of the multilayer pipe according to the present invention are determined so as to meet the functional requirements such as for example burst pressure, flexibility, barrier properties or rigidity at an optimal cost. It is preferred that the outside layer of the multilayer pipe of the present invention has a wall thickness which ranges from at or about 50 to at or about 95%, preferably from at or about 50 to at or about 80%, and the inside layer has a wall thickness ranges from at or about 5 to at or about 50%, preferably from at or about 20 to at or about 50%, the percentage being based on the total wall thickness of the multilayer pipe.

When the multilayer pipe according to the present invention is used to convey liquid media such as for example coolant liquids in vehicles, and especially in automobile cooling systems, it is preferred that the internal diameter of the multilayer pipe is at least at or about 3 mm. For such end-use applications, the thickness of the outside layer is preferably greater than or about 0.3 mm.

Preferably, the multilayer pipes according to the present invention resist burst pressures of at least 30 bars at room temperature after a heat ageing at 120° C. for 1250 hours in presence of a coolant medium (e.g., Glysantin® long life coolant: H₂O (1:1 vol/vol)) (as described in the Examples below). Preferably, the multilayer pipes according to the present invention do not exhibit a rate of coolant medium (e.g., Glysantin® long life coolant: H₂O 1:1) permeation at 90° C. higher than 25 g m⁻² day⁻¹ (as described in the Examples below). Preferably, the multilayer pipes according to the present invention do not absorb the coolant medium (e.g., Glysantin® long life coolant: H₂O 1:1) in an amount greater than 2% when the multilayer pipe is maintained at 60° C. (as described in the Examples below).

According to one embodiment, the walls of the pipes of the present invention are smooth. According to another embodiment, the multilayer pipe according to the present invention can comprise corrugated regions that are interrupted by smooth regions (hereafter called “partially corrugated multilayer pipes”) or can be corrugated all along its length (hereafter called “continuously corrugated multilayer pipes”). Continuously or partially corrugated multilayer pipes according to the present invention enable complex routing of the pipes in constrained spaces, such as those available in underhood areas of automobiles and other vehicles. Such continuously or partially corrugated multilayer pipes can be manufactured by conventional processes like for examples co-extrusion blow molding or corrugated extrusion. During co-extrusion blow molding, a multilayer parison of plastic materials that has been produced by co-extrusion and which is in a hot moldable condition is positioned between two halves of an open blow mold having a mold cavity of a shape appropriate to the required external shape of the article to be manufactured. The parison gradually descends and stretches under the influence of gravity. When the parison reaches the proper length, the mold halves are closed around it and pressurized air or other compressed gas is introduced in the interior of the parison to inflate it to the shape of the mold or to expand it against the sides of the mold cavity. After a cooling period, the mold is opened and the final article is ejected. Other variants of co-extrusion blow molding process are well-known in the art, including, without limitation, suction blow molding and processes involving parison manipulation or laying down. During corrugated extrusion, a tube is formed by the co-extrusion of two or more materials in concentric multilayers. The plastic materials are extruded in a hot moldable state through the pin and the die of an extrusion head. The pin and the die are positioned inside the two halves of the mold blocks of the corrugating equipment. When the molten material coming from the extrusion head reaches the mold blocks, it is drawn up to the shape of the mold article either by heated air or by vacuum expansion against the surface of the mold cavity. Such process is described for example in U.S. Pat. No. 6,764,627, U.S. Pat. No. 4,319,872 or WO 03/055664, which are hereby incorporated by reference.

According to another embodiment and with the aim of enabling complex routing of the multilayer pipes in constrained spaces, such as those available in underhood areas of automobiles and other vehicles the multilayer pipes according to the present invention can consist of an assembly of straight and curved tubular sections, with or without corrugation and that are joined together by specially designed fittings in a leakproof manner. Assemblies according to the present invention comprise one or more multilayer pipes as described above and one or more pipe fittings.

A pipe fitting is a structure designed to connect to at least one pipe end. The fitting may be designed to fit together end-to-end with the pipe, to fit over the pipe end, or be inserted into the pipe end. A fitting may serve, for example, to change the direction of the pipe, to attach the pipe to a support or a fluid reservoir, or to attach the pipe to another pipe.

Conventionally in thermoplastic constructions, the fittings are molded from a rigid thermoplastic material. The fittings are often connected to the tubular sections by a mechanical interference fit. In order to ensure leakproofness of the joint, a metallic clamp is fastened over the joint. While being functional, the need for clamps increases the component count, requires additional assembly step, and thus adds to the total cost.

WO 2004/106038 discloses pipes assemblies comprising at least two concentric layers of thermoplastic material. The process of joining a first and a second pipe comprises several steps including: preparing a first non-planar mating surface at one end of the first pipe; preparing a second non-planar mating surface at one end of the second pipe; heating pipes to soften mating surfaces; bringing pipes into abutment at the mating surface to form a joining zone; and cooling the pipes under compression to solidify the joining zone and forming a weld joining. Mating surfaces can either be linearly tapered, curvilinearly tapered or comprise a plurality of axially projecting teeth and indentions.

The one or more pipe fittings to be used for making the assembly made of one or more of the multilayer pipes according to the invention are chosen to have a high degree of rigidity and to contain internal pressure (same requirement as for the outside layer). Suitable materials are aliphatic and semi-aromatic polyamides, copolyamides, polyesters, copolyetheresters, copolyesteresters, polyurethanes, polyphenylene sulphides, polypropylenes and glass and/or mineral reinforced polymers based on these thermoplastics. The pipe fitting may conveniently be made by injection molding.

The manufacture of the assembly made of one or more of the multilayer pipes according to the invention and one or more pipe fittings, i.e. the bonding of the multilayer pipes according to the present invention to one or more pipe fittings, comprises the steps of:
connecting the pipe fitting to the multilayer pipe end to form a joint;
bonding the multilayer pipe and the pipe fitting by heating the pipe and/or the fitting so as to melt the polymeric composition comprised in the inside layer of the multilayer pipe in the area of the joint; and
allowing the multilayer pipe and the fitting to cool until solidification of the inside layer, so as to form a fluid-tight (i.e. liquid or gas) seal.

Connecting the pipe fitting to the multilayer pipe end may be done for example by inserting the fitting into or over the multilayer pipe. Preferably, connecting the pipe fitting to the multilayer pipe end is done by inserting the fitting into the multilayer pipe end to form a joint prior to the bonding of the multilayer pipe and the pipe fitting by heating so as to seal the joint in a leak-proof manner.

Heating may be performed by any method known to those skilled in the art, such conductively, convectively, via friction or via radiation. Conductive means of heating may include applying a local heating tool to the area of the joint so as to transfer the heat to the inner layer to melt it and affect the joint. Convective means of heating may include subjecting the area of the joint to circulating hot air or a hot fluid medium such as steam or oil. Radiative techniques may include techniques such as laser, electromagnetic induction, infrared or microwave welding. Alternatively frictional welding techniques such as spin welding, vibration welding or ultrasonic welding may be employed.

Cooling of the pipe and the fitting may be done by air, water, or letting the assembly cool under room temperature or ambient conditions, etc.

On solidification of the inside layer of the multilayer pipe according to the present invention, the pipe is firmly bonded to the pipe fitting such that it is resistant to leaks by materials contained in the pipe.

The invention will be further described in the Examples below.

### EXAMPLES

The following materials were used for preparing the multilayer pipes according to the present invention and comparative multilayer pipes:

### Comparative Example 1 (C1)

Inside layer: 41 wt-% of PA 6, 45 wt-% of an ethylene/methacrylic acid copolymer that is partially neutralized with zinc salt), 10 wt-% EBAGMA (ethylene/butyl acrylate/glycidyl methacrylate terpolymer), 2 wt-% of zinc stearate, 1.5 wt-% of N,N′-hexane-1,6-diylbis(3-(3,5-di-tert-butyl-4-hydroxyphenylpropionamide)) and 0.5 wt-% of pentaerythritol tetrakis(3-(3,5-di-tert-butyl-4-hydroxyphenyl)propionate.

Outside layer: 59.88 wt % of PA 612; 25 wt-% of LLDPE; 10 wt-% of MAH-g-PE; 4.22 wt-% of MAH-g-EPDM, 0.5 wt-% of 4,4′-bis(alpha,alpha-dimethylbenzyl)diphenylamine and 0.4 wt-% of tris(2,4-di-tert-butylphenyl)phosphate.

### Comparative Example 2 (C2)

Inside layer: a thermoplastic adhesion-modified elastomer described in U.S. Pat. No. 7,132,141 and supplied by Advanced Elastomer System under the trademark Santoprene® 191-85 PA.

Outside layer: high viscosity PA 12 which is hydrolysis resistant and heat stabilized supplied by EMS under the trademark Grilamid® L25 AH.

### Example 1 (E1)

Inside layer: 51.9 wt-% of LDPE, 23 wt-% EPDM, 25 wt-% MAH-g-PE and 0.1 wt-% of pentaerythritol tetrakis(3-(3,5-di-tert-butyl-4-hydroxyphenyl)propionate.

Outside layer: 59.88 wt % of PA 612; 25 wt-% of LLDPE; 10 wt-% of MAH-g-PE; 4.22 wt-% of MAH-G-EPDM, 0.5 wt-% of 4,4′-bis(alpha,alpha-dimethylbenzyl)diphenylamine and 0.4 wt-% of tris(2,4-di-tert-butylphenyl)phosphate.

### Example 2 (E2)

Inside layer: 71.9 wt-% of PP, 9.5 wt-% of VLDPE, 6.0 wt-% of EPDM; 10 wt-% of MAH-g-PP, 2.5 wt-% of tackifier and 0.1 wt-% of pentaerythritol tetrakis(3-(3,5-di-tert-butyl-4-hydroxyphenyl)propionate.

Outside layer: 59.88 wt % of PA 612; 25 wt-% of LLDPE; 10 wt-% of MAH-g-PE; 4.22 wt-% of MAH-g-EPDM and 0.5 wt-% of 4,4′-bis(alpha,alpha-dimethylbenzyl)diphenylamine and 0.4 wt-% of tris(2,4-di-tert-butylphenyl)phosphate.

The compositions of Examples were prepared by melt blending the ingredients described above in a 90 mm twin screw kneader operating at about 250° C. using a screw speed of about 250 rpm. Upon exiting the extruder, the compositions were cooled and pelletized.

### Extrusion Process:

Two-layer pipes were made by a co-extrusion process with an outside diameter of 8.4 mm and an internal diameter of 6.3 mm. The wall thickness consisted nominally of 20% inside layer material and 80% outside layer material.

The extrusion setup consisted of three individual single-screw extruders connected to a three-layer tubing die. An extruder with a 32 mm (1.25″) single screw available from Polysystems was used for the outside layer of the pipe; an extruder with a 25 mm (1″) single screw available from Barmag was used for the inside layer of the pipe; and an extruder with a 16 mm (⅝″) single screw available from Randcastle can be used for an additional layer made of any suitable thermoplastic polymer composition. Since these two-layer pipes did not need an additional layer, the additional layer extruder was used to supplement the inside layer material. The extrusion line was provided with a die with a 14 mm (0.55″) die body and a 11.4 mm (0.45″) tip. The line speed was in the 4-6 m/min (12-20 ft/min) range. The extruded tube was vacuum sized to the requisite dimensions using an 8.8 mm (0.348″) sizer and 330 mm Hg (13″) of vacuum.

Polymeric compositions were extruded at temperatures profile of: 210 to 240° C. for the polymeric composition used for the inside layer of comparative example 1 (C1); 200 to 240° C. for the polymeric composition used for the outside layer of comparative example 1 (C1) and for the outside layer of examples 1 and 2 (E1 and E2); 250 to 270° C. for the polymeric composition used for the inside layer of comparative example 2 (C2); 220 to 240° C. for the polymeric composition used for the outside layer of comparative example 2 (C2); 180 to 220° C. for the polymeric composition used for the inside layer of example 1 (E1); and 210 to 240° C. for the polymeric composition used for the inside layer of example 2 (E2).

The pipes produced this way were tested according to the following procedures:

1. Coolant Ageing, Cold Impact and Burst Pressure Testing

The two-layer pipes were cut to 91.5 cm long test specimens. Each specimen was closed at one end with an appropriate barbed metal fitting and clamp, and filled with a mixed solution of a commercial automotive long life coolant based on ethylene glycol supplied by BASF under the trademark Glysantin® (hereafter called “Glysantin® LLC”) and water (1:1 vol./vol.)). The other end was then also sealed with the fitting and the clamp.

The pipes were bent in a U-shape with a span of 38 cm between the ends, and suspended in a circulating hot air oven at 120° C. for long term ageing. Specimens were withdrawn periodically at every 250 hours and tested for impact and burst pressure properties as follows. Since the coolant develops a high pressure at the test temperature and the different components have different rates of permeation through the wall, its composition changes over time. In order to compensate for this loss, coolant in each tube was replaced on a weekly basis throughout the duration of the test. Only the actual times the specimens spent in the oven at the ageing temperatures in the oven were considered in the test.

Coolant was drained from specimens withdrawn periodically. The specimens were then cooled to −30° C. in a freezer for several hours. Upon withdrawal, they were quickly tested for impact strength in a falling weight impact tester. The test was done with a puck having a nominal diameter of 25 mm and weighing 200 g that fell from a 50 cm height onto the tube specimen secured in the device. Impact tests were carried out at two locations—one near the end of the pipe and other in the middle-section of the length. After the impact, the sample was examined visually and rated “Pass” if no damage or crack could be seen with the naked eye at about 20 cm distance, and “Fail” if cracks could be seen or complete breakage occurred.

If there was no damage during impact testing, specimens were allowed to warm up to room temperature, and then cut into three pieces nominally 30 cm long. These pieces were tested for burst pressure at room temperature and at 136° C. Burst pressure was measured by attaching the tube piece to the discharge end of a hand-operated water pump supplied by the Barbee Pump Company. The room temperature burst pressure test was done with a hand pump using room temperature water as the hydraulic medium. The 136° C. burst pressure test was done by first equilibrating the samples to the test temperature in a circulating air oven, and then using water as the hydraulic medium. An average burst pressure was calculated for each pipe at each test temperature based on the results of three tested tube pieces.

Results of cold impact testing of pipes filled with coolant and aged at 120° C. as a function of time are given in Table 1.

Results of burst pressure at room temperature are given in Table 2 and results of burst pressure at 136° C. are given in Table 3.

2. Coolant Permeation Test

Specimens of two-layer pipes were sealed at one end, filled with a mixed solution of Glysantin® LLC and water (1:1), and sealed at the other end. The pipes were wiped on the outside and weighed individually. They were then maintained in an environment of circulating air at 90° C. Loss in weight of the pipes was monitored over several days to determine a steady rate of loss due to coolant permeation. This rate was expressed in g/m² surface area of the pipe per day (g m⁻² day⁻¹).

Results are given in Table 4.

3. Coolant Absorption Test

Specimens of two-layer pipes were weighed empty, and then completely immersed in a bath of a mixed solution of Glysantin® LLC and water (1:1) maintained at 60° C. Specimens were withdrawn from the bath periodically, wiped clean to remove surface liquid both inside and outside, and weighed to determine the amount of coolant absorbed. The test was continued to determine maximum coolant absorbed at saturation as a percentage of the original weight of the pipe.

Results are given in Table 5.

4. Bonding of Multilayer Pipe to Fitting

Commercially available plastic barbed fittings supplied by McMaster Carr Co. (part no. 2974K127) and molded from glass-reinforced PA 6 (GR PA 6) were inserted into the ends of the pieces of two-layer pipe of the invention E1. In order to effect bonding, the pipe pieces with the fittings were exposed to circulating air at 150° C. in an oven for 30 minutes with a temporary clamp over the end to ensure intimate contact between the fitting surface and the inner layer of the multilayer pipe. The pipe pieces were then withdrawn, allowed to cool to room temperature and temporary clamps were removed. A strong bond resulted between the fittings and the pipes.

The burst pressures of the pipes with bonded fittings were measured at room temperature and at 136° C. Comparatively, burst pressure was also measured on identical pipe pieces that were provided with either the above mentioned GR PA 6 fittings or brass fittings, but held in place by providing mechanical clamps over the ends. In these latter cases, the assembled pipes and fittings were not heated before burst pressure testing. In these latter cases, there was no bonding of the fittings to the pipe ends. Results are given in Table 6.

TABLE 1
Cold impact testing of pipes filled with coolant
(Glysantin ® LLC:H₂O 1:1) and
aged at 120° C. as a function of time.

| ageing | number. of | | | | |
|---|---|---|---|---|---|
| hours | impact tests | | | | |
| at 120° C. | at −30° C. | C1 | C2 | E1 | E2 |
| 0 | 4 | Pass | Pass | Pass | Pass |
| 250 | 4 | Pass | Pass | Pass | Pass |
| 500 | 4 | Pass | Pass | Pass | Pass |
| 750 | 4 | Pass | Pass | Pass | Pass |
| 1000 | 4 | Pass | Pass | Pass | Pass |
| 1250 | 4 | Fail | Pass | Pass | Pass |

TABLE 2
Burst pressure at room temperature of aged at 120° C. and cold
impacted pipes filled with coolant (Glysantin ® LLC:H₂O 1:1).

| | C1 | C2 | E1 | E2 |
|---|---|---|---|---|
| | burst | burst | burst | burst |
| ageing hours | pressure | pressure | pressure | pressure |
| at 120° C. | (bars) | (bars) | (bars) | (bars) |
| 0 | 70 | 64 | 70 | 77 |
| 250 | 61 | 65 | 67 | 79 |
| 500 | 60 | 64 | 62 | 80 |
| 750 | brittle | 60 | 67 | 82 |
| | & delaminating | | | |
| 1000 | brittle | 71 | 67 | 83 |
| | & delaminating | | | |
| 1250 | failed impact | 34 | 61 | 73 |
| | test | | | |

TABLE 3
Burst pressure at 136° C. of aged at 120° C. and cold impacted
pipes filled with coolant (Glysantin ® LLC:H₂O 1:1).

| | C1 | C2 | E1 | E2 |
|---|---|---|---|---|
| Ageing hours | Burst P | Burst P | Burst P | Burst P |
| at 120° C. | (bars) | (bars) | (bars) | (bars) |
| 0 | 16 | 14 | 14 | 18 |
| 250 | 17 | 16 | 17 | 19 |
| 500 | 16 | 18 | 15 | 18 |
| | pinhole | | | |
| | failures | | | |
| 750 | brittle & | 19 | 16 | 20 |
| | delaminating | | | |
| 1000 | brittle & | 18 | 17 | 19 |
| | delaminating | | | |
| 1250 | failed impact | 17 | 14 | 20 |
| | test | | | |

TABLE 4
Coolant permeation of pipes filled with coolant
(Glysantin ® LLC:H₂O 1:1).

| | rate of coolant permeation at 90° C. |
|---|---|
| multilayer pipe | g m⁻² day⁻¹ |
| C2 | 30 |
| E1 | 16 |
| E2 | 13 |

TABLE 5
Coolant absorption of pipes filled with coolant
(Glysantin ® LLC:H₂O 1:1).

| multilayer pipe | coolant absorbed at 60° C. |
|---|---|
| C2 | 2.22% |
| E1 | 1.55% |
| E2 | 1.41% |

TABLE 6
Burst pressure at room temperature and 136° C. of the pipe of the
invention (E1) with bonded and mechanically attached fittings.

| | RT | 136° C. |
|---|---|---|
| | burst | burst |
| | pressure | pressure |
| | (bars) | (bars) |
| bonded GR PA 6 fitting | 68 | 17 |
| mechanically clamped GR PA 6 | 68 | 14 |
| fitting | | |
| mechanically clamped brass | 70 | 14 |
| fitting | | |

As shown in Table 1, the comparative pipe 1 (C1) comprising polyamide 6 in the outside layer and polyamide 6,12 in the inside layer had poor ageing behavior in presence of coolant and became brittle only after around 500 hours of ageing.

As shown in Tables 2 and 3, the pipes according to the invention (E1 and E2) showed a comparable (if not better) ageing behavior in terms of burst pressure as the comparative pipe 2 (C2) up to 1000 hours of ageing. After an ageing period of 1250 hours, the pipes according to the invention (E1 and E2) retained their burst pressures at room temperature while the comparative pipe 2 (C2) showed a significant drop in its burst pressure.

As shown in Tables 4 and 5, the pipes according to the invention (E1 and E2) showed a considerably reduced rate of permeation and coolant absorption compared to the comparative pipe 2 (C2).

As previously mentioned, a good balance between ageing, burst pressure resistance, liquid permeation resistance and absorption reduction is desirable for pipes used to convey liquid media, and especially coolant liquids, in automotive applications. While the comparative pipe 2 (C2) showed good short term ageing behavior, this pipe showed poor resistance to the coolant liquid in terms of rate of permeation and coolant absorption and inferior long term aging behavior. Surprisingly, the pipes according to the present invention (E1 and E2) exhibit an excellent balance of all these properties.

As shown in Table 6, burst pressure results show that the bond strength of the bonded fittings is similar to that of mechanically clamped fitting. Also, the burst pressure of the pipe according to the present invention (E1) with the bonded fitting is unchanged from that of the pipe itself (see Tables 2 and 3), that is, the bonded fitting does not weaken the pipe's ability to contain the pressure.

### Comparative Example 3 (C3)

A 3 layer pipe was made as follows.

Inside layer: 71.7 wt-% of PP, 9.5 wt-% of VLDPE, 6.0 wt-% of EPDM; 10 wt-% of MAH-g-PP, 2.5 wt-% of tackifier and 0.2 wt-% of pentaerythritol tetrakis(3-(3,5-di-tert-butyl-4-hydroxyphenyl)propionate+0.1% tris(2,4-di-tert-butylphenyl)phosphate.

Middle layer: 98.6% High MW PA 66, 1% 4,4-butylidendebis (6-tert-butyl-m-cresol), 0.18% carbon black colorant and 0.22% ethylene-methyl acrylate copolymer as a carrier for carbon black colorant masterbatch

Outside layer: 55.9 wt % of PA 612; 24.3 wt-% of LLDPE; 9.8 wt-% of MAH-g-PE; 4.2 wt-% of MAH-g-EPDM, 0.5 wt-% of 4,4′-bis(alpha,alpha-dimethylbenzyl)diphenylamine, 0.4% 4,4′ butylidene bis 6-tert-butyl-m cresol, 0.9 wt-% of tris(2,4-di-tert-butylphenyl)phosphate, 1.8% carbon black colorant and 2.2% ethylene-methyl acrylate copolymer as a carrier for carbon black masterbatch

Three-layer pipe was made by a co-extrusion process with an outside diameter of 8.4 mm and an internal diameter of 6.3 mm. The wall thickness consisted nominally of 20% inside layer material, 37% middle layer material, and 43% outside layer material.

The extrusion setup consisted of three individual single-screw extruders connected to a three-layer tubing die. The 32 mm (1.25″) Polysystems single screw extruder was used for the outside layer; the 25 mm (1″) Barmag single screw extruder was used for the inside layer; and the 16 mm (⅝″) Randcastle single screw extruder was used for the middle layer of the pipe. The extrusion line was provided with a die with a 14 mm (0.55″) die body and a 11.4 mm (0.45″) tip. The line speed was 5 m/min (16.6 ft/min). The extruded pipe was vacuum sized to the requisite dimensions using an 8.8 mm (0.348″) sizer and 850 mm Hg (33″) of vacuum.

Extruder temperature profiles were: 190 to 225° C. for the inside layer, 250 to 290 C for the middle layer and 190 to 225 C for the outside layer. Die adapter and die body temperatures were set at 280 C.

### Example 3 (E3)

Inside layer: 71.7 wt-% of PP, 9.5 wt-% of VLDPE, 6.0 wt-% of EPDM; 10 wt-% of MAH-g-PP, 2.5 wt-% of tackifier and 0.2 wt-% of pentaerythritol tetrakis(3-(3,5-di-tert-butyl-4-hydroxyphenyl)propionate+0.1% tris(2,4-di-tert-butylphenyl)phosphate.

Outside layer: 55.9 wt % of PA 612; 24.3 wt-% of LLDPE; 9.8 wt-% of MAH-g-PE; 4.2 wt-% of MAH-g-EPDM, 0.5 wt-% of 4,4′-bis(alpha,alpha-dimethylbenzyl)diphenylamine, 0.4% 4,4′ butylidene bis 6-tert-butyl-m cresol, 0.9 wt-% of tris(2,4-di-tert-butylphenyl)phosphate, 1.8% carbon black colorant and 2.2% ethylene-methyl acrylate copolymer as a carrier for carbon black masterbatch.

A two-layer pipe was made per a similar process as Examples E1 and E2 with an outside diameter of 8.4 mm and an internal diameter of 6.3 mm. The wall thickness consisted nominally of 20% inside layer material and 80% outside layer material. Extruder temperature profiles for both layers were 190 to 225 C. A tubing die with a 14 mm (0.55″) die body and a 11.4 mm (0.45″) tip was used. Die adapter and die body temperatures were set at 225 C. The line speed was in the 6 m/min (20 ft/min). The extruded tube was vacuum sized to the requisite dimensions using an 8.8 mm (0.348″) sizer and 635 mm Hg (25″) of vacuum.

The pipes produced this way were tested according to the test procedures described above for coolant ageing, coolant permeation and coolant absorption except for one change. Coolant ageing test was conducted in a circulating air oven set at 130 C instead of 120 C in order to create a more severe ageing condition.

Results of cold impact testing of pipes filled with coolant and aged at 130° C. as a function of time are given in Table 7.

Results of burst pressure at room temperature are given in Table 8 and results of burst pressure at 136° C. are given in Table 9.

Aged pipes were examined for integrity of layer adhesion as follows. Helical strips about the width of pipe OD and length of about 5 turns were cut out from a sample end at about 45 degrees angle to the pipe axis. The strips were uncoiled into straight pieces, and bent somewhat in the opposite direction. Layer adhesion was examined as a result. It was observed that the layer adhesion was very good in the as-made samples of both C3 and E3 pipes. Layers in both pipes started showing increasing degree of crazing and stress whitening at the interface with increasing ageing time when bent in the opposite direction. This is likely due to stiffening of the pipe material with ageing. These observations are summarized in Table 10.

Results of coolant permeation test are given in Table 11.

Results of coolant absorption test are given in Table 12.

TABLE 7
Cold impact testing of pipes filled with coolant
(Glysantin ® LLC:H₂O 1:1) and
aged at 130° C. as a function of time.

| ageing | number. of | | |
|---|---|---|---|
| hours | impact tests at | | |
| at 120° C. | −30° C. | C3 | E3 |
| 0 | 4 | 4/4 Pass | 4/4 Pass |
| 250 | 4 | 4/4 Pass | 4/4 Pass |
| 500 | 4 | 2/4 fail | 4/4 Pass |
| 750 | 4 | 3/4 Fail | 4/4 Pass |
| 1000 | 4 | 4/4 Fail | 4/4 Pass |
| 1250 | 4 | 4/4 Fail | 1/4 Fail |

TABLE 8
Burst pressure at room temperature of aged at 130° C. and cold
impacted pipes filled with coolant (Glysantin ® LLC:H₂O 1:1).

| | C3 | E3 |
|---|---|---|
| ageing hours | Burst pressure | Burst pressure |
| at 120° C. | (bars) | (bars) |
| 0 | 86 | 71 |
| 250 | 71 | 69 |
| 500 | 23 | 62 |
| 750 | Impact fail | 54 |
| 1000 | Impact fail | 44 |
| 1250 | Impact fail | 16 |

TABLE 9
Burst pressure at 136° C. of aged at 130° C. and cold impacted
pipes filled with coolant (Glysantin ® LLC:H₂O 1:1).

| | C3 | E3 |
|---|---|---|
| Ageing hours | Burst pressure | Burst pressure |
| At 120° C. | (bars) | (bars) |
| 0 | 26 | 15 |
| 250 | 36 | 16 |
| 500 | 19 | 13 |
| 750 | 11 | 13 |
| 1000 | Impact fail | 11 |
| 1250 | Impact fail | 13 |

TABLE 10
Layer adhesion in pipes filled with coolant and aged at 130 C.

| | | E3 |
|---|---|---|
| Ageing hours | C3 | Burst pressure |
| At 120° C. | Layer adhesion | (bars) |
| 0 | Good | Good |
| 250 | OK | OK |
| 500 | OK | OK |
| 750 | Impact fail | OK |
| 1000 | Impact fail | OK |
| 1250 | Impact fail | OK |

TABLE 11
Coolant permeation of pipes filled with coolant
(Glysantin ® LLC:H₂O 1:1).

| | rate of coolant permeation at 90° C. |
|---|---|
| multilayer pipe | g m⁻² day⁻¹ |
| C3 | 17 |
| E3 | 13 |

TABLE 12
Coolant absorption of pipes filled with coolant
(Glysantin ® LLC:H₂O 1:1).

| multilayer pipe | coolant absorbed at 60° C. |
|---|---|
| C3 | 3% |
| E3 | 1.5% |

Note that the 3-layer comparative pipe 3 (C3) has the same inside and outside layers as the 2-layer pipe 3 according to the present invention (E3). The difference is that comparative pipe 3 (C3) has an additional layer of high Mw PA 66 to provide a stronger pipe with higher initial burst pressure. Nevertheless, as shown in Tables 7 to 10, it is not able to retain burst pressure and cold impact toughness as well as the 2-layer pipe 3 according to the present invention (E3) through the ageing test. As shown in Tables 11 and 12, pipe (E3) also shows a considerably reduced rate of permeation and coolant absorption compared to the comparative pipe 3 (C3).

1. A multilayer pipe comprising at least two layers,
i) an inside layer comprising
a) from at or about 65 to at or about 90 wt-% of at least two polymers, one of which is a polyethylene, polypropylene, or a combination thereof, and the other is an ethylene alpha-olefin copolymer, an ethylene propylene diene rubber (EPDM), or a combination thereof; and
b) from at or about 10 to at or about 35 wt-% of at least one functionalized polyolefin,
the weight percentages being based of the total weight of the inside layer, and
ii) an outside layer comprising:
a) from at or about 50 to at or about 80 wt-% of at least one aliphatic polyamide derived from monomers comprising at least one diamine having 6 to 14 carbon atoms and at least one aliphatic dicarboxylic acid having 9 to 18 carbon atoms;
b) from at or about 10 to at or about 30 wt-% of one or more functionalized polyolefins or maleic anhydride grafted ethylene/alpha-olefin copolymer or maleic anhydride grafted ethylene-propylene diene rubber or a combination thereof; and
c) from at or about 0 to at or about 30 wt-% of linear low density polyethylene (LLDPE),
wherein the weight percentages are based on the total weight of the outside layer; and
wherein the inside layer contacts the outside layer.

2. The multilayer pipe according to claim 1 comprising at least two layers, wherein
i) the inside layer comprises:
a) from at or about 65 to at or about 90 wt-% of at least two polymers, one of which is a polyethylene, polypropylene, or a combination thereof, and the other is an ethylene alpha-olefin copolymer, an ethylene propylene diene rubber (EPDM), or a combination thereof; and
b) from at or about 10 to at or about 35 wt-% of maleic anhydride grafted polyethylene (MAH-g-PE) or maleic anhydride grafted polypropylene (MAH-g-PP),
the weight percentages being based of the total weight of the inside layer, and
ii) the outside layer comprises:
a) from at or about 50 to at or about 80 wt-% of polyamide 610, polyamide 612; polyamide 1012; polyamide 1212; and/or polyamide 1010;
b) from at or about 10 to at or about 30 wt-% of maleic anhydride grafted polyethylene (MAH-g-PE), or maleic anhydride grafted polypropylene (MAH-g-PP) or maleic anhydride grafted ethylene alpha-olefin copolymer or maleic anhydride grafted ethylene-propylene diene rubber or a combination thereof; and
c) from at or about 0 to at or about 30 wt-% of linear low density polyethylene (LLDPE),
the weight percentages being based on the total weight of the outside layer.

3. The multilayer pipe according to claim 1 or 2 comprising at least two layers, wherein
i) the inside layer comprises:
a) from at or about 65 to at or about 90 wt-% of at least two polymers, one of which is a polyethylene, polypropylene, or a combination thereof, and the other is an ethylene alpha-olefin copolymer, an ethylene propylene diene rubber (EPDM), or a combination thereof; and
b) from at or about 10 to at or about 35 wt-% of maleic anhydride grafted polyethylene (MAH-g-PE) or maleic anhydride grafted polypropylene (MAH-g-PP),
the weight percentages being based of the total weight of the inside layer, and
ii) the outside layer comprises:
a) from at or about 50 to at or about 75 wt-% of polyamide 612;
b) from at or about 10 to at or about 30 wt-% of maleic anhydride grafted polyethylene (MAH-g-PE), or maleic anhydride grafted polypropylene (MAH-g-PP) or maleic anhydride grafted ethylene alpha-olefin copolymer or maleic anhydride grafted ethylene-propylene diene rubber or a combination thereof;
c) from at or about 0 to at or about 30 wt-% of linear low density polyethylene (LLDPE),
the weight percentages being based on the total weight of the outside layer.

4. The multilayer pipe according to any preceding claim, wherein the wall thickness of the outside layer is from at or about 50 to at or about 95% of the total wall thickness of the multilayer pipe and the wall thickness of the inside layer is from at or about 5 to at or about 50% of the total wall thickness of the multilayer pipe.

5. The multilayer pipe according to claim 1, wherein the at least one aliphatic polyamide is selected from one or more of the group consisting of polyamide 610, polyamide 612; polyamide 1012; polyamide 1212; and polyamide 1010.

6. The multilayer pipe according to any preceding claim, wherein the internal diameter of the multilayer pipe is at least about 3 mm.

7. The multilayer pipe according to any preceding claim, wherein the thickness of the outside layer is at least about 0.3 mm.

8. The multilayer pipe according to any preceding claim further comprising one or more additional layers, which additional layers are situated over the outside layer or inside the inside layer of the multilayer pipe defined in claims 1 to 7.

9. The multilayer pipe according to any preceding claim, which comprises corrugated regions that are interrupted by smooth regions.

10. The multilayer pipe according to claims 1 to 8, which is a corrugated multilayer pipe.

11. A pipe assembly comprising one or more of the multilayer pipes as defined in any claims 1 to 10 and one or more pipe fittings.

12. The pipe assembly according to claim 11, wherein the one or more pipe fitting are made of at least one thermoplastic polymer chosen among aliphatic and semi-aromatic polyamides, copolyamides, polyesters, copolyetheresters, copolyesteresters, polyurethanes, polyphenylene sulphides and polypropylenes.

13. The pipe assembly according to claim 11, wherein the one or more pipe fitting are made of glass and/or at least one mineral reinforced polymer chosen among aliphatic and semi-aromatic polyamides, copolyamides, polyesters, copolyetheresters, copolyesteresters, polyurethanes, polyphenylene sulphides and polypropylenes.

14. A method for bonding one or more multilayer pipes as defined in claims 1 to 10 to one or more pipe fittings, comprising the steps of:
a) connecting the pipe fitting to the multilayer pipe end to form a joint;
b) bonding the multilayer pipe and the pipe fitting by heating the pipe and/or the fitting so as to melt the polymeric composition comprised in the inside layer of the multilayer pipe in the area of the joint; and
c) allowing the multilayer pipe and the fitting to cool until the inside layer solidifies, so as to form a fluid-tight seal.

15. The method according to claim 14, wherein the step of connecting the pipe fitting to the multilayer pipe end is done by inserting the pipe fitting into the multilayer pipe end to form a joint.

16. The method according to claim 14 or 15, wherein the step of bonding the multilayer pipe and the pipe fitting is done by conductively heating, convectively heating or by radiation.

17. The method according to any one of claims 14 to 16, wherein the one or more pipe fittings are made of a thermoplastic polymer chosen among aliphatic and semi-aromatic polyamides, copolyamides, polyesters, copolyetheresters, copolyesteresters, polyurethanes, polyphenylene sulphides and polypropylenes.
